(19) United States
(12) Patent Application Publication
(10) Pub. No.: US 2018/0163945 A1
(43) Pub. Date: Jun. 14, 2018

(54) LIGHTING MEANS ARRANGEMENT AND METHOD FOR PRODUCING SAME

(71) Applicant: Deutsche Institute für Textil- und Faserforschung Denkendorf, Denkendorf (DE)

(72) Inventors: Hansjürgen Horter, Oberboihingen (DE); Stefan Loy, Denkendorf (DE); Sebastian Stoll, Stuttgart (DE); Paul Hofmann, Illertissen (DE)

(21) Appl. No.: 15/552,439

(22) PCT Filed: Feb. 16, 2016
(86) PCT No.: PCT/EP2016/053252

§ 371 Date: Mar. 1, 2018

(30) Foreign Application Priority Data
Feb. 20, 2015 (DE) 10 2015 102 406.3

(51) Int. Cl. F21V 3/02; F21V 33/00; F21S 9/02; A41D 27/08; A41D 1/02; A41D 1/00; A41D 13/01

(52) U.S. Cl. CPC F21V 3/02; F21V 33/0008; F21S 9/02; F21Y 2115/10; A41D 1/02; A41D 1/002; A41D 13/01; A41D 27/085

(57) ABSTRACT

The invention relates to a lighting means arrangement (28) and to a method for producing same. The lighting means arrangement (28) comprises at least one lighting means (20), for example a light-emitting diode chip (21) comprising at least one light emission surface (22). A cover body (24) is associated with one or more lighting means, covering at least one light emission surface (22) and being connected to the lighting means (20) in a bonded manner. A scattering element arrangement (37) is associated with each of the cover bodies (24). The scattering element arrangement (37) is connected to the cover body (24) in a bonded manner, for example, using adhesion or moulding. The scattering element arrangement (37) comprises at least one coherent textile material part (38), for example a woven and/or a knitted and/or a interlaced and/or a non-woven material. The at least one textile material part (38) is used to at least partially bend and/or refract and/or reflect and/or absorb the light coupled into the cover body (24). In this way, the light emission characteristic of the lighting means arrangement (28) can be influenced, and adjusted to the use of the lighting means arrangement (28).

The invention relates to an illuminant arrangement, with at least one illuminant, for example, a semiconductor illuminant such as a light-emitting diode. The illuminant arrangement is particularly adapted for use in articles of clothing. The illuminant arrangement, when used in an article of clothing, can serve to increase the visibility of the person wearing the clothing and/or to display information to other persons, such as an identification of an operational force, for example, rescue, security, or support personnel.

U.S. Pat. No. 8,690,385 B2 describes a light-emitting electronic textile. Light-emitting diodes are arranged on a flexible substrate and inserted into a textile tube. This textile tube can be attached to a garment. However, it has been found that the diffusion effect in such embodiments is frequently insufficient and therefore there is no two-dimensional visual effect from the light emission. Some embodiments of U.S. Pat. No. 8,690,385 B2 provide for several textile layers to be arranged between the light-emitting diodes and the emission side of the surrounding textile tube, in which the individual layers are spaced by air layers. This results in a refractive index at the boundary layer between a textile layer and an adjacent air layer. However, the disadvantage of this design is the increased thickness of the tube. In addition, the refractive effect is greatly changed when the tube is in motion and, for example, if air gaps are not maintained and boundary layers are thereby at least partially eliminated. This can adversely affect the visual effect of the two-dimensional light emission.

The purpose of the present invention is to provide an illuminant arrangement, which can achieve a good diffusion effect in a compact design. This objective is resolved by an illuminant arrangement with the features of patent claim 1. A method according to the invention for producing an illuminant arrangement is specified in claim 17.

The illuminant arrangement has at least one illuminant. A semiconductor illuminant, such as a light-emitting diode, is preferably used as illuminant. Preferably, the at least one illuminant is a substantially point-like emitting illuminant respectively. Such a point-like emitting illuminant has a virtual initial point from which the light mainly spreads out radially within a light emission area. The light emission area can be designed symmetrically or asymmetrically with respect to an optical axis of the illuminant. The light emission area is, for example, a ball segment.

The illuminant arrangement has at least one cover. Preferably, each light source is assigned a separate cover, which covers a light-emitting surface of the illuminant, from which light is emitted by the illuminant. It is also possible for a group of several illuminants, for example 2 to 5 illuminants, to be covered by a common cover. The cover is preferably materially connected to the at least one of the respectively assigned illuminant.

The at least one cover is transparent for the light emitted by the respective illuminant, and thus it is transparent for a light wavelength or wavelength range of the light emitted by the assigned illuminant.

Each cover body is materially connected with a diffusing element arrangement. The diffusing element arrangement is adapted to at least partly diffract and/or refract and/or reflect the light emitted by the at least one illuminant and coupled into the cover body. For this purpose, the diffusing element arrangement has at least one cohesive textile material piece or consists of one cohesive textile material piece. The cohesive textile material piece can be an area-measured textile fabric and, so to speak, 2.5-dimensional or 3-dimensional. A fleece material piece or woven fabric piece or knitted fabric piece can be used as area-measured textile fabric for the cohesive textile material. Warp knitted material pieces or knitted material pieces can be used as knitted fabric.

Such cohesive textile material pieces have a fiber structure or yarn structure. The diffusing effect can be easily influenced by means of the material used and/or the density of the fibers or yarns and/or the orientation of the fibers or yarns and/or by means of the knitting or weaving construction and/or by means of the cross-sectional form of the yarn or fiber and/or by means of the density of the textile material and/or the number of textile material pieces used in the diffusion element arrangement. The density of the textile material can be defined for example by the distance of directly adjacent fibers or yarns for a woven fabric or knitted fabric (mesh width or density of warp and weft yarns respectively) and by the average distance of the filaments for a fleece material. The diffusion is so to speak at least partly defined by means of the porosity of the textile material.

Since the diffusion element arrangement is materially bonded to the cover body and thus directly or indirectly connected with the illuminant as well, the orientation of the diffusion element arrangement in relation to the emitted light is always maintained. Thus a light emission profile for each illuminant can be predefined and maintained. Cohesive textile material pieces can be manufactured easily by usual methods, like weft knitting, warp knitting, weaving or by fleece manufacturing. Symmetric and asymmetric manipulation of the emission characteristic can be achieved easily and defined by means of the at least one cohesive textile material piece. Contrary to that, so far a plurality of single diffusing particles that were integrated in a substrate material, for example a cast material, was frequently used. However, the arrangement and distribution in the cast material is often only achievable with high efforts, particularly if a defined different diffusion effect shall be adjusted in different areas of the light emission profile.

Preferably each illuminant contains a light-emitting diode chip, at which the at least one light-emitting surface is present. Such a light-emitting diode chip can, additionally to its light-emitting surface, also emit light at lateral surfaces that are adjacent to the main light-emitting surface.

It is preferred, if the material bond between the diffusion element arrangement and the cover body is created when manufacturing the cover body. The material bond can be created during and as a result of the manufacturing of the cover body. Thus the cover body can be manufactured in a one-step process and can be concurrently material bonded with the diffusion element arrangement and optionally additionally with the at least one illuminant. The cover body can be formed by at least one casting body.

The at least one textile material piece of the diffusion element arrangement can be at least partly imprinted and/or colored. The at least one textile material piece can also be multicolored. It is thus possible to at least partly absorb light in the printed or colored areas and thus modify the light emission characteristic of the illuminant arrangement accordingly.

It is preferred that the porosity and/or the mesh size of the at least one textile material piece is different in different areas. The porosity is here considered as volume of the filaments or yarn divided through the volume of the textile material piece or through the volume of a section of the textile material piece. In so doing the diffusion effect can be manipulated or adjusted differently in different areas of the light emission area of an illuminant. Additionally or alternatively the main orientation direction of the filaments or yarn can be different in different areas of the textile material piece. In a preferred embodiment the diffusion element arrangement contains multiple textile material pieces.

It is preferred, if in different angular sections of the light emission area of each illuminant a different number of and/or differently formed textile material pieces are arranged.

In one embodiment textile material pieces can be present arranged one above the other in the respective main emission direction of the light of at least one illuminant. The textile material pieces can create several layers, so to speak, that have to be passed by the light starting from the illuminant until the emission from the illuminant arrangement.

The main emission direction of the light of an illuminant is the direction into which the light would propagate without restrictions. The main emission direction of the light is radial to a virtual initial point in one preferred embodiment if a approximately point-like light source is concerned.

It is also advantageous, if at least two of the textile material pieces of the diffusion element arrangement have different main orientations of the filaments and/or yarn relative to the respective main emission direction of the light that enters in the respective textile material piece. Thus, for example, a first textile material piece can have a main orientation of the filaments or yarn in a first spatial direction and a second material piece can have a main orientation of the filament or yarn in a second direction relative to the main emission direction of the light that is different from the first direction. For example the first direction can be tangential to the radial main emission direction of the light, whereas the second direction can be tilted or at a right angle to the first direction.

The cover body can be materially bonded and/or force-fit and/or form-fit connected with the at least one assigned illuminant. In a preferred embodiment the cover body can be formed by a cast body. It is also possible that the cover body is formed by a separately manufactured lens body that is connected by material bond and/or force-fit and/or form-fit with the diffusion element arrangement or the illuminant respectively after its manufacturing.

In one embodiment several or all illuminants can be arranged on a common carrier. It is thereby possible to arrange or create electric conductors in or at the carrier for connection of the illuminant arranged on the carrier. The conductors can be directly integrated by weaving or weft knitting or warp knitting or integrated in the carrier or arranged at the carrier by means of sewing or knitting. A textile strip or another textile fabric can be used as carrier for example.

The illuminants of the illuminant arrangement can be connected electrically in series and/or parallel. Preferably at least one electric series resistor is present, if the illuminants are operated at a voltage source. Particularly a separate series resistor can be assigned to each respective group of one or more illuminants. It is also possible to connect each of the illuminants separately with an assigned voltage or current source.

The illuminant arrangement described above can be manufactured according to the invention as follows:

First a casting mold with at least one mold cavity is provided. At least one of the illuminants is inserted in each of the mold cavities. Additionally, at least one textile material piece is inserted in each mold cavity. Subsequently a flowable casting material is inserted into the mold cavity, such that it covers the at least one light-emitting surface and gets into contact with the at least one textile material piece. By curing the casting material, the at least one cover body is created. Due to the curing also a material bond connection is created between the at least one cover body, the at least one textile material piece and the at least one illuminant.

Optionally only the at least one textile material piece can be inserted in the mold cavity. Due to the curing an arrangement consisting of the cover body and the diffusion element arrangement is created. This arrangement can be connected subsequently outside the casting mold with the at least one illuminant particularly with the at least one light-emitting diode chip.

Preferred embodiments of the invention are obvious from the dependent patent claims, the description and the drawings. Subsequently preferred embodiments of the invention are explained in detail by means of the attached drawings. The drawings show:

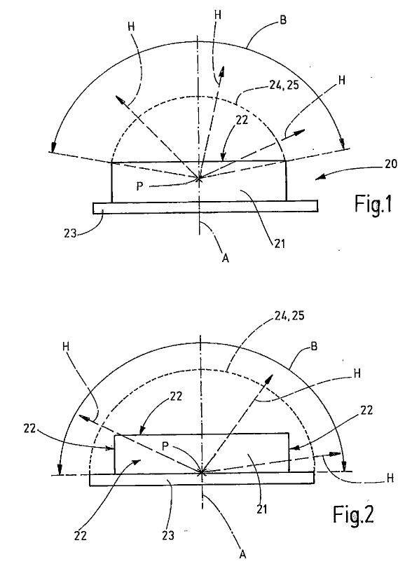

FIGS. 1 and 2 a schematic block diagram like illustration of an illuminant and its light emission area respectively,

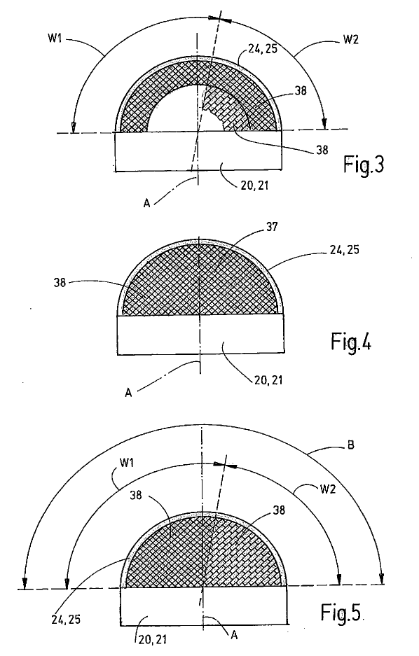

FIGS. 3-9 an embodiment of an illuminant with a cover body and a diffusion element arrangement respectively in a schematic, block-diagram-like side view,

FIG. 10 schematic perspective illustration of an embodiment of an illuminant arrangement,

FIG. 11 a circuit diagram of an embodiment of an electric connection of the illuminants of an illuminant arrangement,

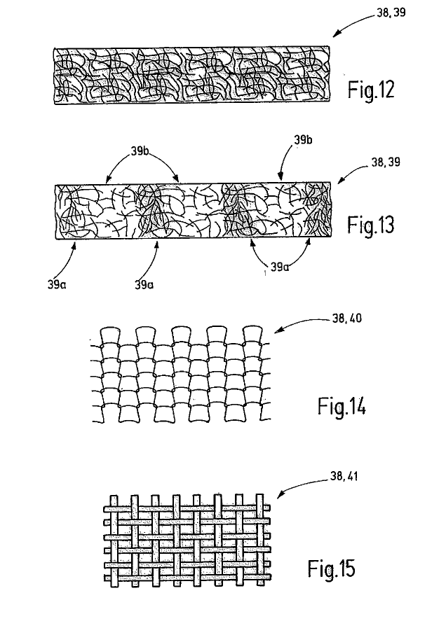

FIGS. 12 and 13 each an embodiment of a textile material piece as area-measured textile fabric in a schematic cross-section view that is formed by a fleece material here,

FIG. 14 a schematic illustration of a textile material piece as area-measured textile fabric in the form of knitted fabric,

FIG. 15 a textile material piece as area-measured textile fabric in the form of a woven fabric and

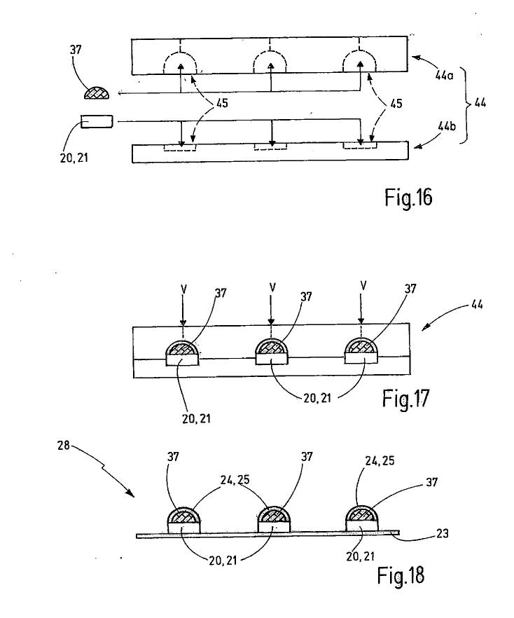

FIG. 16-18 a schematic operation sequence of a method for manufacturing an illuminant arrangement according to an embodiment.

In FIGS. 1 and 2 highly schematic embodiments of illuminants 20 with at least one light-emitting surface 22 are shown, that are embodied as semiconductor illuminants and contain a light-emitting diode chip according to the example. In the embodiment according to FIG. 1 the light-emitting surface 22 is provided at the side of the light-emitting diode chip 21 that faces away from a carrier 23, on which the light-emitting diode chip 21 is arranged.

The illuminant 20 and according to the example the light-emitting diode chip 21 provides an approximately point-like light source. The light is emitted within a light emission area B around an optical axis A. The light emission area B can be rotationally symmetrical with regard to the optical axis A or symmetric to a plane of symmetry that extends radially to the optical axis A or can be neither axis-symmetric nor symmetric to a radial plane along the optical axis A.

In the embodiment shown in FIG. 1 the light-emitting diode chip 21 contains a single light-emitting surface 22. The light emission area B is thereby smaller than 180 degrees in relation to an initial point P of the approximately point-like light source. In the embodiment shown in FIG. 2 the light emission area B relative to the initial point P can have 180 degrees or can also be larger than 180 degrees. The light-emitting diode chip 21 has several and according to the example five light-emitting surfaces 22 in this embodiment, because it can emit the light also from the side surfaces.

The illuminant 20 and, according to the example, the light-emitting diode chip 21 is covered at least at its at least one light-emitting surface 22 by a cover body 24. The cover body 24 is illustrated in dotted lines in FIGS. 1 and 2. It has for example a dome-shaped or ball scraper shaped form. The cover body 24 is substance bonded to the illuminant 20 according to the example. Additionally, it can also be substance bonded to the carrier 23. The cover body 24 can also have an arbitrary other contour, for example a cuboid-shaped contour.

In the embodiment the cover body 24 is formed by a casting element 25. Alternatively the cover body 24 can be formed as lens body. The cover body 24 consists of a material that is at least partly transparent for the light emitted by the light-emitting diode chip 21. Preferably the material of the casting body is transparent for white light.

In FIG. 10 an embodiment of the illuminant arrangement 28 with multiple illuminants 20 is schematically illustrated. As shown, several of the present illuminants 20 can be arranged on a common carrier 23. It is also possible to arrange all of the illuminants 20 of an illuminant arrangement 28 on a common carrier 23.

The illuminants 20 and, according to the example, the light-emitting diode chips 21 are electrically connected in series and/or parallel with each other. Thereto electric conductors 29 can be arranged in or at the carrier 23. The carrier can be formed by a textile fabric like, for example, a woven fabric, a knitted fabric or another coherent textile material piece. The conductors 29 can be integrated in such a textile carrier 23 by means of flexible conductors. In a modification hereto each illuminant 20 can be separately connected with an assigned voltage or current source.

An exemplary electric circuit for operating of the illuminant arrangement 28 is illustrated in FIG. 11. The illuminants 20 are thereby divided in several groups 30. The illuminants 20 of one group 30 are connected in series. Additionally a series resistor 31 is connected in series to each group 30. The series connections of series resistor 31 and the group 30 of illuminants 20 are in turn connected in parallel with each other and are electrically connected with a voltage source 32. A battery or an accumulator can serve as voltage source 32. Alternatively thereto it is also possible to operate the illuminant arrangement 28 by means of a current source.

The embodiment of the illuminant arrangement 28 according to FIGS. 10 and 11 can be advantageously used in an article of clothing, for example in a jacket. There it can be employed for creating a panel light that allows recognizability of a person carrying the article of cloth or its identification. For example in the case of articles of clothing for action forces, such as police officers, firefighting personnel, rescue forces, etc. the recognizability can be increased by means of the integrated illuminant arrangement 28 independent from the light conditions and the external circumstances. Additionally, information like symbols, letters, numbers, etc. can be displayed by a respective imprinting or design of the light-emitting outer layer of the article of clothing. The action forces can thus be identified, which is for example common in large police operations. With such a use the operation of the illuminant arrangement 28 at a voltage source is simply possible.

In another modification of the illuminant arrangement 28 shown in FIG. 10 it is also possible to assign a common cover body 24 to several illuminants 20 or light-emitting diode chips 21 respectively, for example to a group 30 of illuminants 20. A group 30 can for example contain two to five illuminants 20.

The illuminant arrangement 28 additionally contains a diffusion element arrangement 37. A diffusion element arrangement 37 is assigned to each cover body 24 and is material bonded with the cover body. If a casting body 25 is used as cover body 24, the diffusion element arrangement 37 can be at least partly cast in the casting body 25 when manufacturing the casting body 25, such that the material bond is already created during and due to the manufacturing of the casting body 25. In the described preferred embodiments a cover body 24 and thus also a separate diffusion element arrangement 37 is assigned to each illuminant 20. As already explained, a cover body 24 with a diffusion element arrangement 37 could also be assigned to a group 30 of illuminants.

The illuminant arrangement 37 serves to at least partly diffract and/or refract and/or reflect the light emitted from the at least one illuminant 20 and coupled in the respective cover body. Thus a diffusion effect can be achieved. Therefore, a panel light can be created by means of the illuminant arrangement, whose illumination surface does not contain large brightness differences and provides a good visual impression of a two-dimensional light emission.

Each diffusion element arrangement 37 therefore contains at least one coherent textile material piece 38. A coherent textile material piece 38 means a textile structure that contains filaments or yarn that are entangled and/or woven and/or otherwise directly connected with each other in an appropriate manner. The textile material piece 38 is preferably embodied as fleece material piece 39 (FIGS. 12 and 13), as fabric piece 40 (FIG. 14) or as woven fabric piece 41 (FIG. 15). The knitted fabric piece 40 can be manufactured by weft knitting or warp knitting.

If a woven fabric piece 41 is used as textile material piece 38, any suitable weaving construction, like plain weave, twill weave, atlas weave, leno weave or the like can be used. Three-dimensional woven fabric can be used with two woven layers, that are connected by means of pile yarns with each other.

The fleece material piece 39 can be manufactured by compacting single fibers. The fibers can be entangled with each other by means of fluid jets and/or needles. It is also possible to connect single fibers with each other by spraying up and curing a binder.

The fleece material piece 39 can have a substantially uniform distribution of fibers and thus a uniform porosity (FIG. 12). Porosity hereby means the ratio between the volume of the fibers and the total volume of the fleece material piece. Different to the embodiment shown in FIG. 12, in another embodiment according to FIG. 13 the fleece material piece can also have zones compacted differently. It can contain first zones 39a with a lower porosity or a higher fiber density and second zones 39b with a larger porosity compared with the first zones 39a. It is to be understood that also three or more zones with respective different porosities can be present. The porosity of the fleece material piece 39 influences the diffusion effect of a diffusion element arrangement 37 containing the fleece material piece 39. Dependent from the location at which the zones with different porosities are arranged, the emission characteristic of the respective assigned illuminant 20 or the respective assigned illuminants 20 can be influenced and adjusted according to specific presettings.

The diffusion effect can be influenced by the material used and/or the density of the fibers or yarn respectively and/or by the orientation of the fibers and yarn respectively and/or by the knitting or weaving construction and/or by the cross-section form of the yarn or fiber respectively and/or by the density of the textile material and/or the number of textile material pieces used in the diffusion element arrangement. The density of the textile material can be defined, for example in case of a woven fabric or a knitted fabric by the distance of directly adjacent yarn or filaments (mesh width or warp and weft thread density respectively) and in case of a fleece material 39 by means of the average distance of the filaments. The diffusion is at least partly defined by the porosity of the textile material so to speak.

In a knitted fabric piece 40 or a woven fabric piece 41 the mesh size of the mesh width influences amongst others the diffusion effect. In all embodiments of a textile material piece 38 the diffraction, refraction, reflection or also absorption by the selection of the material of the filaments or yarn respectively, their color, their size or titer and their orientation with respect to the main emission direction H of the light can influence the diffusion effect of the diffusion element arrangement. The main emission direction H of the light here means in case of the exemplary point-like light source the radial direction at the respective location, at which the light enters the diffusion element arrangement 37 or the textile material piece 38 respectively, starting from the initial point P. In FIGS. 1 and 2 some of the main emission directions H for the emitted light are illustrated by way of example.

In modified embodiments it is also possible in case of knitted fabric or woven fabric to achieve partial different diffusion effects analog to the illustration of the fleece material piece in FIG. 13. For example partially different densities of the textile material piece 38 can be provided, for example by means of yarn or fiber sections in the knitted fabric or woven fabric without binding (non-woven fabric section or float). The diffusion effect can be modified section by section by means of partial patching.

FIGS. 3-9 show different embodiment possibilities for arranging the diffusion element arrangement 37 at a cover body 24 or at an illuminant 20 respectively. In the embodiment according to FIG. 3, the diffusion element arrangement 37 contains at least one textile material piece 38. According to the example the at least one textile material piece 38 forms a layer of the diffusion element arrangement 37 in each case. If multiple textile material pieces 38 are present, they can be arranged on top of each other in the main emission direction H of the light, such that the light has to pass through multiple textile material pieces 38 before it is emitted from the cover body 24 in the environment. The shape of the single layers or textile material pieces respectively can be adapted to the shape of the cover body 24. If the cover body 24 is embodied in a ball scraper shape, the single textile material pieces 38 can be approximately adapted to the curvature of the ball scraper. Thereby both the inner side that faces toward the light-emitting surface as well as the outer side of the textile material piece that faces away from the light-emitting surface can be curved. In modification thereto it is also possible to adapt only one of the two sides, particularly the outer side of the textile material piece 38 to the curvature of the cover body and to adapt the inner side to the assigned light-emitting surface and for example arrange it in a plane, in which the light-emitting surface 22 is also present or in a plane parallel thereto (FIGS. 4, 5 and 7-9).

The light-emitting area B of the illuminant 20 can be divided into angular sections W, in which the diffusion element arrangement 37 is embodied differently and thus creates different diffusion effects in the light emission characteristic. For example the light emission area B is divided into a first angular section W1 and a second angular section W2 in the embodiments according to FIGS. 3 and 5. In the embodiment shown in FIG. 3 one textile material piece 38 is arranged in both angular sections W1, W2, whereas in the second angular section W2 an additional textile material piece 38 is arranged, such that in this second angular section W2 the light is at least partly diffracted and/or reflected and/or refracted and/or absorbed by means of this additional textile material piece 38. Thus the scattering or diffusion can be adjusted differently in the different angular sections W1, W2.

Alternatively to the embodiment according to FIG. 3 it is for example also possible to arrange differently embodied textile material pieces 38 in the different angular sections W1, W2. For example the textile material pieces 38 can have a different porosity or mesh width. They can alternatively or additionally also distinguish in other characteristics from each other, for example in the material used, in the filament or yarn thickness, in the color of the filaments or yarn, etc. One or more of the characteristics that influence the light emission can be selected differently, such that the light emission in the two angular sections W1, W2 is different. It is for example possible to limit the intensity of the emitted light at each location within a specific angular section W1, W2 to a maximum value in order to reduce the blinding effect. If the illuminant arrangement 28 is for example used integrally in an article of clothing, the blinding of a person who carries the article of clothing can be prevented in this way.

Generally multiple textile material pieces 38 with different characteristics can be combined arbitrarily in a diffusion element arrangement 37. In the FIGS. 7-9 further arrangement possibilities of multiple textile material pieces 38 are illustrated by way of example. In these embodiments the cover body 24 has a cuboid shape. The arrangement possibilities of the textile material pieces 38 of these embodiments can be used in principle also in differently shaped cover bodies 24, e.g. also in ball scraper shaped cover bodies 24.

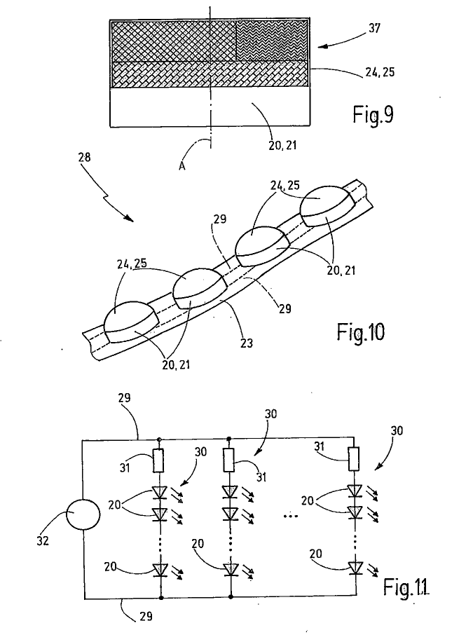

As illustrated in FIG. 7 two or more textile material pieces 38 can be arranged adjacent to each other on the light-emitting surface 22 of the light-emitting diode chip 21. Additionally or alternatively it is also possible to arrange multiple textile material pieces 38 in the direction of the optical axis A next to or above each other, which is for example shown in FIG. 8. In FIG. 9 the arrangement possibilities of FIGS. 7 and 8 are combined.

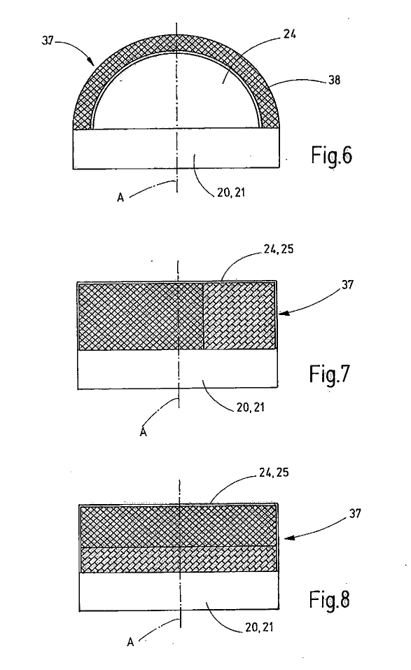

In the embodiment shown in FIG. 6 the diffusion element arrangement 37 is connected to the cover body 24 by means of an adhesive bond and can be arranged at its outer side for example. In this embodiment the light is manipulated by means of the diffusion element arrangement 37 only, if it exits the cover body 24 and is coupled into the at least one textile material piece 38 of the diffusion element arrangement 37. In this embodiment, different to the illustration of FIG. 6, one or more textile material pieces 38 could also be arranged inside the cover body 24 itself, as it is the case in the other embodiments according to FIGS. 3-5 and 7-9.

Additionally or alternatively to the use of multiple textile material pieces 38 with different light-influencing characteristics it is also possible to select the porosity and/or the mesh size of at least one the used textile material pieces 38 differently in different areas or zones.

In all of the embodiments a textile material piece can be completely or partly colored or imprinted, or e.g. in order to absorb light of a specific light wavelength in specific zones or angular sections W1, W2 of the light emission area B by means of the textile material piece 38.

In the arrangement of different textile material pieces 38 the main orientation of the filaments or yarn of the respective textile material piece 38 also plays a role for its diffusion effect. It is possible, e.g. in a fleece material piece 39 entangled by fluid jets or needles, to differently orientate the main orientation of the fibers with respect to the respective main emission direction H at the location, at which the light enters into the fleece material piece 39, in order to create the desired diffusion effect. In the case of different fleece material pieces 39, this can be done in a way that they are positioned in a desired orientation with respect to their respective main emission direction H of the light. It is also possible to achieve a different main orientation of the fibers in the zones 39a, 39b of a fleece material piece 39 in each case. For example by means of needling the main orientation of the filaments can be orientated in the direction of the impacting fluid jets or needles. The fleece material piece 39 can then be positioned in a desired orientation relative to the main emission direction H of the light opposite the illuminant 20.

Also when using a knitted fabric piece 40 or a woven fabric piece 41 as textile material piece 38 the plane, in which the yarn extends, can be orientated relative to the main emission direction H or the optical axis A respectively. As explained, the orientation of the filaments or yarn respectively can be selected differently in different angular sections W1, W2 or other sections or areas of the diffusion element arrangement 37.

In FIGS. 16-18 a method for manufacturing an illuminant arrangement 28 is illustrated highly schematically. For this a casting mold 44 with one or more mold cavities 45 is provided. The casting mold 44 has preferably a first mold part 44a and a second mold part 44b, wherein each mold part can comprise a section of the mold cavity 45 respectively. When the casting mold 44 is open, a diffusion element arrangement 37 and according to the example also a light-emitting diode chip 21 are placed in each mold cavity 45 (FIG. 16). Subsequently the casting mold 44 is closed. When the casting mold is closed, a casting material V is introduced in the mold cavity 45. The casting material V thereby gets in contact with the at least one light-emitting surface 22 of the light-emitting diode chips 21 as well as the diffusion element arrangement 37 (FIG. 17). Due to the curing of the casting material V, the cover body 24 is created as casting body 25 and a material bond connection is established between the casting body 25 and the diffusion element arrangement 37 as well as the light-emitting diode chip 21.

Subsequently the illuminants 20 that are each connected with a casting body 25 and a diffusion element arrangement 37 can be arranged on a carrier 23 (FIG. 18). By this arrangement the electric connections with the conductors 29 are established as well.

As an alternative thereto it is also possible to arrange the carrier 23 in the casting mold 44 before inserting the casting material V and to select the mold cavity 45 such that the casting material V also gets into contact with the carrier 23. Thus also a material bond connection with the carrier 23 can already be created when manufacturing the casting body 25, which further simplifies the manufacturing of the illuminant arrangement 28. Additionally, the at least one illuminant 20 is preferably electrically and/or preliminarily mechanically connected at the carrier 23 before the insertion into the mold cavity 45, e.g. by means of a solder or bond connection. Thus the at least one illuminant 20 is fixed and orientated in the mold cavity 45.

The arrangement of the gate and outlet opening of the casting mold 44 and/or the casting pressure may selectively manipulate the relative position of the at least one textile material piece 38 in relation to the at least one illuminant 20. Due to the injection in the mold cavity 45 at the side of the textile material piece 38 that is facing away from the illuminant 20, the textile material piece 38 is forced toward the illuminant 20 due to the injected casting material (FIG. 17). If the gate openings are arranged at the opposite side, that means at the side of the illuminant 20 that is facing away from the textile material piece 38, the textile material piece 38 is forced away from the illuminant 20 due to the injected casting material. Thus the position of the textile material piece 38 inside the casting body 35 can be influenced.

In a further modification it is also possible to only insert the diffusion element arrangement 37 in the mold cavity 35 and to create a substance bond connection between the casting body 25 and the diffusion element arrangement 37 by curing the casting material V. Subsequently the arrangement comprised of the casting body 25 and the diffusion element arrangement 37 can be made substance bonded and/or force-fit connected and/or form-fit connected with the at least one assigned illuminant 20.

The invention relates to an illuminant arrangement 28 as well as a method for its manufacturing. The illuminant arrangement 28 comprises at least one illuminant 20, for example a light-emitting diode chip 21 with at least one light-emitting surface 22. A cover body 24 is assigned to one or more illuminants that covers the at least one light-emitting surface 22 and is preferably material bond connected with the illuminant 20. A diffusion element arrangement 37 is assigned to each cover body 24. The diffusion element arrangement 37 is substance bonded with the cover body 24, e.g. by gluing or molding. The diffusion element arrangement 37 comprises at least one coherent textile material 38 that can be for example a woven fabric and/or weft knitted fabric and/or warp-knitted fabric and/or fleece fabric. The at least one textile material piece 38 serves to at least partially defract and/or refract and/or reflect and/or absorb light that is coupled into the cover body 24. Thus the light emission characteristic of the illuminant arrangement 28 can be influenced and adapted to the use of the illuminant arrangement 28.

### REFERENCE SIGN LIST

20 Illuminant
21 Light-emitting diode chip
22 Light-emitting surface
23 Carrier
24 Cover body
25 Casting body
28 Illuminant arrangement
29 Electric conductor
30 Group
31 Series resistor
32 Voltage source
37 Diffusing element arrangement
38 Textile material piece
39 Fleece material piece
39a First zone of the fleece material piece
39b Second zone of the fleece material piece
40 Knitted fabric piece
44 Casting mold
44A First mold part
44b Second mold part
45 Mold cavity
A Optical axis
B Light emission area
H Main emission direction
P Initial point
W1 First angular section
W2 Second angular section

1. Illuminant arrangement (28)
with at least one illuminant (20), having at least one light-emitting surface (22), at which the illuminant (20), emits light,
with at least one cover body (24) from a material which is at least partially transparent for the emitted light that covers the at least one light radiating surface (22) and is connected with the at least one illuminant (20),
wherein a diffusing element arrangement (37) is substance bond connected to each of the cover bodies (24), that is adapted to at least partially diffract and/or refract and/or reflect and/or absorb the light emitted from at least one illuminant (20) and coupled into the cover body (24),
wherein the diffusing element arrangement (37) comprises at least one cohesive textile material piece (38) or consists of at least one cohesive textile material piece.

2. An illuminant arrangement according to claim 1,
characterized in that each illuminant (20) is a light source, which emits the light substantially radially with respect to an initial point (P) within a light emission area (B).

3. An illuminant arrangement according to claim 1,
characterized in that each illuminant (20) is a light source, which emits the light essentially linearly or laminary within a light emission area (B).

4. An illuminant arrangement according to one of the preceding claims,
characterized in that each illuminant (20) comprises a light-emitting diode chip (21), on which at least one light-emitting surface (22) is present.

5. An illuminant arrangement according to one of the preceding claims,
characterized in that the substance bond of the diffusing element arrangement (37) with the cover body (24) is produced during the manufacture of cover body (24).

6. An illuminant arrangement according to one of the preceding claims,
characterized in that each illuminant (20) or a group (30) with multiple illuminants (20) each comprises a separate cover body (24).

7. An illuminant arrangement according to one of the preceding claims,
characterized in that the at least one textile material piece (38) is a fleece material piece (39) and/or a woven fabric piece (41) and/or a knitted fabric piece (40).

8. An Illuminant arrangement according to one of the preceding claims,
characterized in that the at least one textile material piece (38) is at least partially imprinted and/or colored.

9. An illuminant arrangement according to one of the preceding claims,
characterized in that the porosity and/or the material used and/or the density of the fibers or yarn and/or orientation of the fibers or yarn and/or the knitting or weaving construction and/or the cross-sectional shape of the yarn or the fiber and/or the density or porosity of the textile material of the at least one textile material piece (38) is different in different areas.

10. The illuminant arrangement according to one of the preceding claims,
characterized in that multiple textile material pieces (38) are present.

11. The illuminant arrangement according to claim 10,
characterized in that each illuminant (20) has a light emission area (B), wherein in different angular sections (W1, W2) of light emission area (B) a different number of textile material pieces (38) and/or differently embodied textile material pieces (38) are arranged.

12. An illuminant arrangement according to claim 10 or 11,
characterized in that several textile material pieces (38) arranged one above the other are present in the respective main emission direction (H) of the light of the at least one illuminant (20).

13. An illuminant arrangement as claimed in one of claims 10 to 12,
characterized in that at least two of the textile material pieces (38) of the diffusing element arrangement (37) have different main orientations of the fibers and/or yarn relative to the respective main emission direction (H) of the light which enters the respective textile material piece (38).

14. An illuminant arrangement according to one of the preceding claims,
characterized in that the cover body (24) is formed by a casting body (25) or a lens body.

15. An illuminant arrangement according to one of the preceding claims,
characterized in that several or all illuminants (20) are arranged on a common carrier (23).

16. An illuminant arrangement according to one of the preceding claims,
characterized in that the at least one diffusing element arrangement (37) determines the light-emitting profile of illuminant (20).

17. A method for manufacturing an illuminant arrangement (28) with at least one illuminant (20) which has at least one light-emitting surface (22) from which the illuminant (20) emits light, with at least one cover body (24) of a material that is at least partially transparent for the emitted light, with at least one diffusing element arrangement (37), that is adapted to at least partially diffract and/or refract and/or reflect and/or to absorb the light emitted from the at least one illuminant (20) and coupled into the cover body (24), wherein the diffusing element arrangement (37) comprises at least one cohesive textile material piece (38) or consists of at least one cohesive textile material piece (38), with the following steps:
providing a casting mold (44) with at least one mold cavity (45),
placing at least one textile material piece (38) into each mold cavity (45),
introducing flowable casting material (V) into the mold cavity (45) so that the casting material (V) contacts the at least one textile material piece (38),
curing the casting material (V) for producing the at least one cover body (24), wherein a substance bond between the at least one cover body (24) and the at least one textile material piece (38) is created in each mold cavity (45).

18. The method according to claim 17,
characterized in that at least one of the illuminants (20) is inserted into each mold cavity (45) prior to introducing of casting material (V), the introduced casting material (V) covering the at least one light-emitting surface (22), such that a substance bond is produced between the at least one cover body (24) and the at least one illuminant (20) by curing of the casting material (V).
